(19) United States
(12) Patent Application Publication
(10) Pub. No.: US 2014/0089666 A1
(43) Pub. Date: Mar. 27, 2014

(54) TIME SYNCHRONIZATION IN A MACHINE TO MACHINE COMMUNICATION

(71) Applicants: Euijik Kim, Seoul (KR); Jeongil Bae, Seoul (KR); Deokmoon Chang, Seoul (KR); Sungsook Yoon, Seoul (KR); Yuseon Kim, Seoul (KR)

(72) Inventors: Euijik Kim, Seoul (KR); Jeongil Bae, Seoul (KR); Deokmoon Chang, Seoul (KR); Sungsook Yoon, Seoul (KR); Yuseon Kim, Seoul (KR)

(73) Assignee: KT CORPORATION, Gyeonggi-do (KR)

(21) Appl. No.: 14/116,941

(22) PCT Filed: May 7, 2012
(86) PCT No.: PCT/KR2012/003570

§ 371 Date: Nov. 11, 2013

(30) Foreign Application Priority Data
May 13, 2011 (KR) 10-2011-0045421

(51) Int. Cl. H04L 9/08

(52) U.S. Cl. CPC H04L 9/0819
USPC 713/170

(57) ABSTRACT

The present disclosure is related to performing a time synchronization between entities in a machine to machine (M2M) communication.

### TECHNICAL FIELD

The present disclosure relates to performing a time synchronization between entities in a machine to machine (M2M) communication.

### BACKGROUND ART

Machine to machine (M2M) communication may be variously referred to as a machine type communication (MTC), Internet of things (IoT), a smart device communication (SDC), or a machine oriented communication (MOC). The M2M communication may refer to a variety of communications which can be performed without human intervention in the process of communication. The M2M communication may be used in such various fields as an intelligent metering (a smart metering), an electronic health (e-health), a home appliance communication (a connected consumer), a city automation, an automotive application, and the like.

In such M2M communication, each entity may have an internal clock. In this case, time information indicated by the internal clock is required to be accurate and reliable. Furthermore, such time information is required to be protected from a variety of possible malicious attacks.

### DISCLOSURE OF INVENTION

### Technical Problem

An objective of the present embodiment is to provide a method of protecting time information from a malicious attack and performing a time synchronization between entities in an M2M communication system.

### Technical Solution

In order to accomplish the above-described objective, in accordance with at least one embodiment, a method may be provided for performing a time synchronization in a machine to machine (M2M) communication system. The method may include receiving, by a second entity, an encrypted message from a first entity, wherein the encrypted message is created by encrypting time information in the first entity, using a key shared with the second entity; obtaining, by the second entity, the time information by decrypting the encrypted message; and calculating, by the second entity, a time offset based on the time information and a reception time of the encrypted message.

In accordance with another embodiment, a method may be provided for performing a time synchronization in a machine to machine (M2M) communication system. The method may include creating, by a first entity, a message by encrypting time information using a key shared with a second entity; and transmitting, by the first entity, the encrypted message to the second entity.

In accordance with still another embodiment, a machine to machine (M2M) device may be provided for being coupled to a different M2M entity through a personal area network or a local area network and for sharing a key with the M2M entity. The M2M device may include a communication processor and an encryption processor. The communication processor may be configured to receive an encrypted message from the M2M entity. Herein, the encrypted message is created by encrypting time information using the key, in the M2M entity. The encryption processor may be configured to obtain the time information by decrypting the encrypted message, and to calculate a time offset based on the time information and a reception time of the encrypted message.

In accordance with still another embodiment, a machine to machine (M2M) device may be provided for being coupled to a different M2M entity through a personal area network or a local area network, and sharing a key with the M2M entity. The M2M device may include an encryption processor and a communication processor. The encryption processor may be configured to create a message by encrypting time information using the key shared with the M2M entity. The communication processor may be configured to transmit the encrypted message to the M2M entity.

In accordance with another embodiment, a method may be provided for performing a time synchronization in a machine to machine (M2M) communication system. The method may include receiving, by a second entity, a first message at a second time, when a first entity (i) creates the first message by encrypting a first time information using a key shared with the second entity, and (ii) transmits the first message to the second entity at a time corresponding to the first time information; obtaining, by the second entity, the first time information by decrypting the first message; creating, by the second entity, a second message by encrypting the first time information, information on the second time, and a third time information using the key; and transmitting, by the second entity, the second message to the first entity, at a time corresponding to the third time information.

In accordance with another embodiment, a method may be provided for performing a time synchronization in a machine to machine (M2M) communication system. The method may include creating, by a first entity, a first message by encrypting a first time information using a key shared with a second entity; transmitting, by the first entity, the first message to the second entity; receiving, by the first entity, a second message at a fourth time, when the second entity (i) creates the second message by encrypting the first time information, a second time information associated with a first message reception of the second entity, and a third time information, using the key, and (ii) transmits the second message at a time corresponding to the third time information; obtaining, by the first entity, the first time information, the second time information, and the third time information by decrypting the second message; and calculating, by the first entity, a time offset based on the first time information, the second time information, the third time information, and information on the fourth time.

In accordance with still another embodiment, a machine to machine (M2M) device may be provided for communicating with an M2M platform. The M2M device may include a communication processor and an encryption processor. The communication processor may be configured to receive a first message at a second time, in the case that the M2M platform creates the first message by encrypting a first time information using a key shared with the M2M device, and transmits the first message to the M2M device at a time corresponding to the first time information. The encryption processor may be configured (i) to obtain the first time information by decrypting the first message, and (ii) to create a second message by encrypting the first time information, information on the second time, and a third time information using the key. Furthermore, the communication processor may be configured to transmit the second message to the M2M platform, at a time corresponding to the third time information.

In accordance with still another embodiment, a machine to machine (M2M) gateway may be provided for communicating with an M2M platform. The M2M gateway may include a communication processor and an encryption processor. The communication processor may be configured to receive a first message at a second time, in the case that the M2M platform creates the first message by encrypting a first time information using a key shared with the M2M gateway, and transmits the first message to the M2M gateway at a time corresponding to the first time information. The encryption processor may be configured (i) to obtain the first time information by decrypting the first message, and (ii) to create a second message by encrypting the first time information, information on the second time, and a third time information using the key. Furthermore, the communication processor may be configured to transmit the second message to the M2M platform, at a time corresponding to the third time information.

In accordance with still another embodiment, a machine to machine (M2M) device may be provided for communicating with a different M2M device or an M2M gateway. The M2M device may include a communication processor and an encryption processor. The communication processor may be configured to receive a first message at a second time, in the case that the different M2M device or the M2M gateway creates the first message by encrypting a first time information using a key shared with the M2M device, and transmits the first message to the M2M device at a time corresponding to the first time information. The encryption processor may be configured (i) to obtain the first time information by decrypting the first message, and (ii) to create a second message by encrypting the first time information, information on the second time, and a third time information using the key. Furthermore, the communication processor may be configured to transmit the second message to the different M2M device or the M2M gateway, at a time corresponding to the third time information.

In accordance with still another embodiment, a machine to machine (M2M) platform may be provided for communicating with an M2M device or an M2M gateway, and an application server, and providing a function shared by an application of the application server. The M2M platform may include an encryption processor and a communication processor. The encryption processor may be configured to create a first message by encrypting a first time information using a key shared with the M2M device or the M2M gateway. The communication processor may be configured (i) to transmit the first message to the M2M device or the M2M gateway; and (ii) to receive a second message at a fourth time, in the case that the M2M device or the M2M gateway (a) creates the second message by encrypting the first time information, a second time information associated with a first message reception of the M2M device or the M2M gateway, and a third time information, using the key, and (b) transmits the second message at a time corresponding to the third time information. Furthermore, the encryption processor may be configured to obtain the first time information, the second time information, and the third time information by decrypting the second message; and to calculate a time offset based on the first time information, the second time information, the third time information, and information on the fourth time.

In accordance with still another embodiment, a machine to machine (M2M) gateway may be provided for communicating with an M2M device. The M2M gateway may include an encryption processor and a communication processor. The encryption processor may be configured to create a first message by encrypting a first time information using a key shared with the M2M device. The communication processor may be configured (i) to transmit the first message to the M2M device; and (ii) to receive a second message at a fourth time, in the case that the M2M device (a) creates the second message by encrypting the first time information, a second time information associated with a first message reception of the M2M device, and a third time information, using the key, and (b) transmits the second message at a time corresponding to the third time information. Furthermore, the encryption processor may be configured to obtain the first time information, the second time information, and the third time information by decrypting the second message; and to calculate a time offset based on the first time information, the second time information, the third time information, and information on the fourth time.

In accordance with still another embodiment, a machine to machine (M2M) device may be provided for communicating with a different M2M device. The M2M device may include an encryption processor and a communication processor. The encryption processor may be configured to create a first message by encrypting a first time information using a key shared with the different M2M device. The communication processor may be configured (i) to transmit the first message to the different M2M device; and (ii) to receive a second message at a fourth time, in the case that the different M2M device (a) creates the second message by encrypting the first time information, a second time information associated with a first message reception of the different M2M device, and a third time information, using the key, and (b) transmits the second message at a time corresponding to the third time information. Furthermore, the encryption processor may be configured to obtain the first time information, the second time information, and the third time information by decrypting the second message; and to calculate a time offset based on the first time information, the second time information, the third time information, and information on the fourth time.

### Advantageous Effects

According to the above-described embodiments, an M2M communication system may protect time information from a malicious attack and perform a time synchronization between entities.

### BRIEF DESCRIPTION OF THE DRAWINGS

FIG. 1 illustrates a structure of an M2M communication system to which at least one embodiment may be applied.

FIG. 2 illustrates a hierarchy of keys to be used in the present embodiments.

FIG. 3 is a flowchart illustrating performing a time synchronization in accordance with Embodiment 1.

FIG. 4 illustrates a system to which Embodiment 2 may be applied.

FIG. 5 is a time-series diagram of performing a time synchronization in accordance with Embodiment 2.

FIG. 6 is a block diagram illustrating a structure of an M2M device in accordance with Embodiment 2.

FIG. 7 illustrates a system to which Embodiment 3 may be applied.

FIG. 8 is a time-series diagram of performing a time synchronization in accordance with Embodiment 3.

FIG. 9 is a block diagram illustrating a structure of an M2M gateway in accordance with Embodiment 3.

FIG. 10 is a block diagram illustrating a structure of an M2M device in accordance with Embodiment 3.

FIG. 11 illustrates a structure of a resource to be applied to the present embodiments.

### MODE FOR CARRYING OUT THE INVENTION

Hereinafter, exemplary embodiments of the present invention will be described with reference to the accompanying drawings. In the following description, the same elements will be designated by the same reference numerals although they are shown in different drawings. Furthermore, in the following description of the present embodiment, a detailed description of known functions and configurations incorporated herein will be omitted when it may make the subject matter of the present embodiment unclear.

The present embodiments will be described based on an M2M communication. Herein, the M2M communication may be variously referred to as a machine type communication (MTC), Internet of things (IoT), a smart device communication (SDC), or a machine oriented communication (MOC). The M2M communication may refer to a variety of communications which can be performed without human intervention in the process of communication. The M2M communication may be used in such various fields as an intelligent metering (a smart metering), an electronic health (e-health), a home appliance communication (a connected consumer), a city automation, an automotive application, and the like.

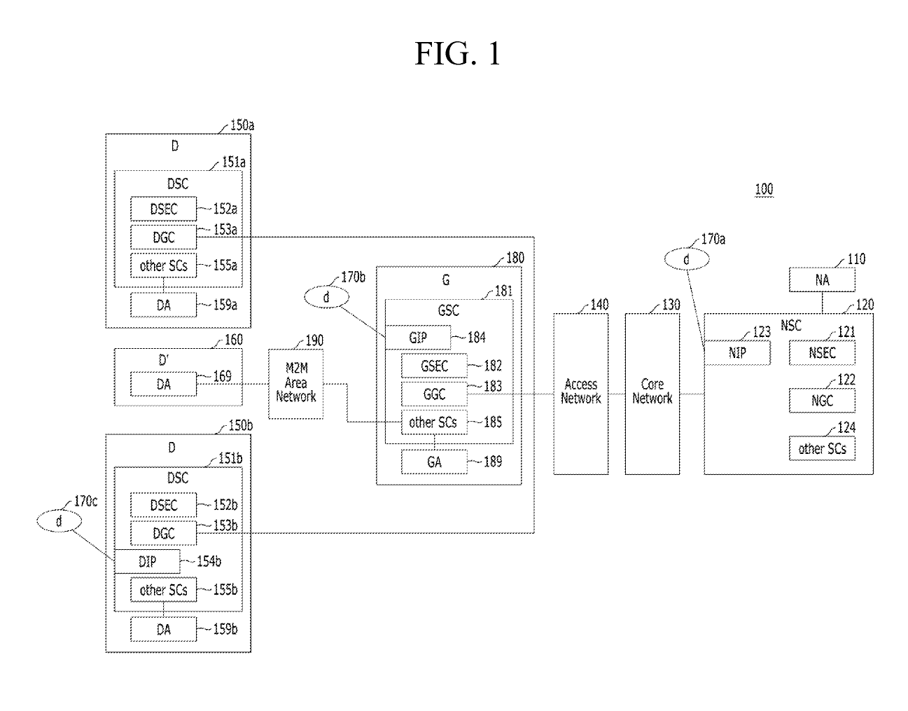

FIG. 1 illustrates a structure of an M2M communication system (may be referred to as “an M2M system”) to which at least one embodiment may be applied.

Referring to FIG. 1, M2M communication system 100 may include network application server (hereinafter referred to as “NA”) 110, M2M service capability server (hereinafter referred to as “NSC”) 120 (or may be referred to as “an M2M platform”), core network 130, access network 140, M2M devices 150a, 150b, 160, 170a, 170b, and 170c, M2M gateway 180, and M2M area network 190 (e.g., a local network).

NA 110 may be an application server. NA 110 may provide user interfaces.

NSC 120 or an M2M platform may be a server providing M2M functions which are shared by a variety of applications. NSC 120 may be operated by a provider different from a provider of NA 110.

NSC 120 may include service capabilities (hereinafter referred to as “SCs”) 121 through 124 providing functions which are shared by a variety of applications.

Among them, network security capability (NSEC) 121 may perform ‘security related functions’ such as an M2M service registration, authentication, and/or a key management for the authentication.

Network generic communication (NGC) capability 122 may be used for a message transmission between M2M gateway 180, M2M devices 170a and 170b, and SCs 121, 123, and 124 in NSC 120.

Network interworking proxy (NIP) capability 123 may be used to communicate with device 170a which does not conform to a predetermined M2M standard.

In addition, NSC 120 may include a plurality of different SCs 124.

NSC 120 may connect to core network 130 through NGC 122. Core network 130 may provide connectivity means including internet protocol (IP) connectivity at a minimum.

Access network 140 may be a network which allows M2M gateway 180 and M2M devices 150a and 150b to communicate with core network 130. For example, access network 140 may include a digital subscriber line (xDSL), a hybrid fiber coaxial (HFC), a power line communication (PLC), a satellite, a GSM edge radio access network (GERAN), a UMTS terrestrial radio access network (UTRAN), an evolved UMTS terrestrial radio access network (eUTRAN), a wireless local area network (W-LAN), a worldwide interoperability for microwave access (WiMAX), and the like.

An M2M device may be connected to access network 140 (i) directly, (ii) through an M2M gateway, or (iii) through a different M2M device. Alternatively, an M2M device may be controlled by NSC 120, outside of core network 130 and/or access network 140.

M2M devices 150a and 150b may be directly connected to access network 140. M2M devices 150a and 150b may perform such procedures as authentication, authorization, registration, management, and provisioning. M2M devices 150a and 150b may include device service capabilities (or device service capabilities modules) (hereinafter referred to as “DSCs”) 151a and 151b, and device application modules (hereinafter referred to as “DAs”) 159a and 159b. DSCs 151a and 151b may provide functions which are shared by applications executed in DAs 159a and 159b.

DSCs 151a and 151b may include service capabilities (SCs) providing functions which are shared by device applications. The SCs in DSCs 151a and 151b may include device security capabilities (DSECs) 152a and 152b. Herein, DSECs 152a and 152b may perform security related functions such as an M2M service registration, authentication, and/or a key management for the authentication. The SCs in DSCs 151a and 151b may include device generic communication (DGC) capabilities 153a and 153b. Herein, DGC capabilities 153a and 153b may perform a message transmission between NGC 122 and SCs 152a, 155a, 152b, 154b, and 155b in DSCs 151a and 151b. The SCs in DSCs 151a and 151b may include a device interworking proxy (DIP) capability (e.g., 154b) for a communication with an M2M device (e.g., 170c) which does not conform to a predetermined M2M standard. Furthermore, the SCs in DSCs 151a and 151b may include a plurality of different SCs 155a and 155b.

M2M device 160 may connect to access network 140 through M2M gateway 180. M2M device 160 may connect to M2M gateway 180 using M2M area network 190.

M2M device 160 may include a device application module (e.g., DA 169). However, M2M device 160 may not provide service capabilities (SCs) for applications.

M2M gateway 180 may act as a proxy for an M2M network towards M2M device 160 that is connected to M2M gateway 180. M2M gateway 180 may perform such procedures as authentication, authorization, registration, management, and provisioning, in association with the connected M2M device 160.

M2M gateway 180 may include gateway service capability (or gateway service capability module) (hereinafter referred to as “GSC”) 181 and gateway application module (hereinafter referred to as “GA”) 189. GSC 181 may provide functions which are shared by applications executed in GA 189. Furthermore, GSC 181 may provide functions which are required for applications executed in DA 169.

GSC 181 may include service capabilities (SCs) providing functions which are shared by gateway application executed in GA 189 or device applications executed in DA 169. The SCs in GSC 181 may include gateway security capability (GSEC) 182. Herein, GSEC 182 may perform security related functions such as an M2M service registration, authentication, and/or a key management for the authentication. The SCs in GSC 181 may include gateway generic communication (GGC) capability 183. Herein, GGC capability 183 may perform a message transmission between NGC 122 and SCs 182, 184, and 185 in GSC 181. The SCs in GSC 180 may include gateway interworking proxy (GIP) capability 184 for a communication with an M2M device (e.g., 170b) which does not conform to a predetermined M2M standard. Furthermore, the SCs in GSC 180 may include a plurality of different SCs 185.

M2M area network 190 may provide connectivity between M2M device 160 and M2M gateway 180. For example, M2M area network 190 may be a personal area network (PAN) or a local area network (LAN). Herein, the PAN may include ‘institute of electrical and electronics engineers’ (IEEE) 802.15.x, Zigbee, ‘Internet engineering task force (IETF) routing over low power and lossy networks (ROLL),’ international society of automation (ISA)100.11a, and so forth. The LAN may include power line communication (PLC), Meter-BUS (M-BUS), wireless M-BUS, KNX, and so forth.

Meanwhile, M2M devices 170a, 170b, and 170c may not conform to a predetermined M2M standard. M2M devices 170a, 170b, and 170c may communicate with NSC 120, M2M gateway 180, or other M2M devices (e.g., 150b). As described above, such communications may be performed through NIP 123, GIP 184, or DIP 154b.

In the above-described M2M device, M2M devices 150a and 150b that can directly connect to an access network (e.g., access network 140) may be referred to as “D-type.” M2M device 160 which can connect to an access network (e.g., access network 140) through M2M gateway 180 connected to M2M area network 190 may be referred to as “D′-type.” M2M devices 170a, 170b, and 170c that do not conform to a predetermined M2M standard and are connected to NSC 120, M2M gateway 180, and a different M2M device (e.g., M2M device 150b), respectively, may be referred to as “d-type.”

NSEC 121, DSEC 152a and 152b, and GSEC 182 may perform a security related procedure using keys.

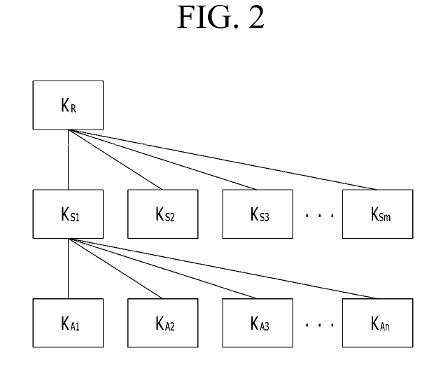

FIG. 2 illustrates a hierarchy of keys to be used in the present embodiments.

Referring to FIG. 2, keys may include a root key K_{R}, service keys K_{S1} to K_{Sm}, and application keys K_{A1} to K_{An}.

The root key K_{R} may be generated by an M2M device/gateway (e.g., M2M devices 150a and 150b, or M2M gateway 180) and an M2M service bootstrap function (MSBF) during a service bootstrap. The root key K_{R} may be generated based on access network credentials or a pre-provisioned bootstrapping credentials. In the case that a service registration is performed by the M2M device/gateway (e.g., M2M devices 150a and 150b, or M2M gateway 180) and an M2M authentication server (MAS), the root key K_{R} may be used for a mutual authentication between an M2M device/gateway (e.g., M2M devices 150a and 150b, or M2M gateway 180) and NSC 120, and for a generation of a service key (K_{S}).

During the service registration, the service key K_{S} may be generated by the M2M device/gateway (e.g., M2M devices 150a and 150b, or M2M gateway 180) and the MAS. The service key K_{S} may be generated based on the root key K_{R}. The service key K_{S} may be used for an application key (K_{A}) generation of DSEC/GSEC (i.e., DSEC 152a or 152b, or GSEC 182) and NSEC 121.

During an application registration, the application key K_{A} may be generated by DSEC/GSEC (i.e., DSECs 152a and 152b, or GSEC 182) and NSEC 121. The application key K_{A} may be generated based on the service key K_{S} and an application identifier. The application key K_{A} may be used for authentication/authorization of applications and protection of an application data transmission of DGC/GGC (i.e., DGC 153a and 153b, or GGC 183) and NGC 122.

The root key K_{R}, the service key K_{S}, and the application key K_{A} as described above may correspond to an exemplary embodiment, but the present embodiments are not limited thereto. Keys which can be shared by different entities may be used in the present embodiments.

Furthermore, as described above, Keys may be handled by such service capabilities (SCs) as xSEC (e.g., NSEC, DSEC, GSEC) or xGC (e.g., NGC, DGC, GGC), but the present embodiment are not limited thereto. For example, M2M devices 160, 170a, 170b, and 170c not having SCs may also include a memory supporting environments for a key storage.

In a system of FIG. 1, a time synchronization may be required between each entity. In a variety of M2M applications, time information along with location information may have an important role. For example, time information might be used in an M2M device with an application for tracking a moving object.

Basically, a time synchronization mechanism providing an accuracy of time information may be relatively weak to a variety of malicious attacks. For example, the time synchronization mechanism may be under such attacks as a masquerade attack, a replay attack, a message manipulation attack, and a delay attack. Herein, the masquerade attack may correspond to an attack where a malicious entity (i.e., attacker) illegally has (or uses) identity of a different entity and performs communications like the different entity (i.e., pretends to be the different entity). The replay attack may correspond to an attack pretending to be a legitimate user, by (i) selecting and duplicating a valid message from protocols and (ii) retransmitting the duplicated message later. The message manipulation attack may correspond to an attack modifying a message. The delay attack may correspond to delaying time messages.

A time synchronization may be established between NSC 120 and M2M devices 150a and 150b, or between NSC 120 and M2M gateway 180. Herein, communications between NSC 120 and M2M devices 140a and 140b, or between NSC 120 and M2M gateway 180 may be performed using core network 130 and access network 140. Further, a time synchronization may be established between M2M gateway 180 and M2M device 160 which communicate using M2M area network 190. Furthermore, a time synchronization may be established between (i) M2M devices 170a, 170b, and 170c which do not conform to M2M standards, and (ii) entities (e.g., 120, 150b, and 180) which conform to the M2M standards.

### Embodiment 1

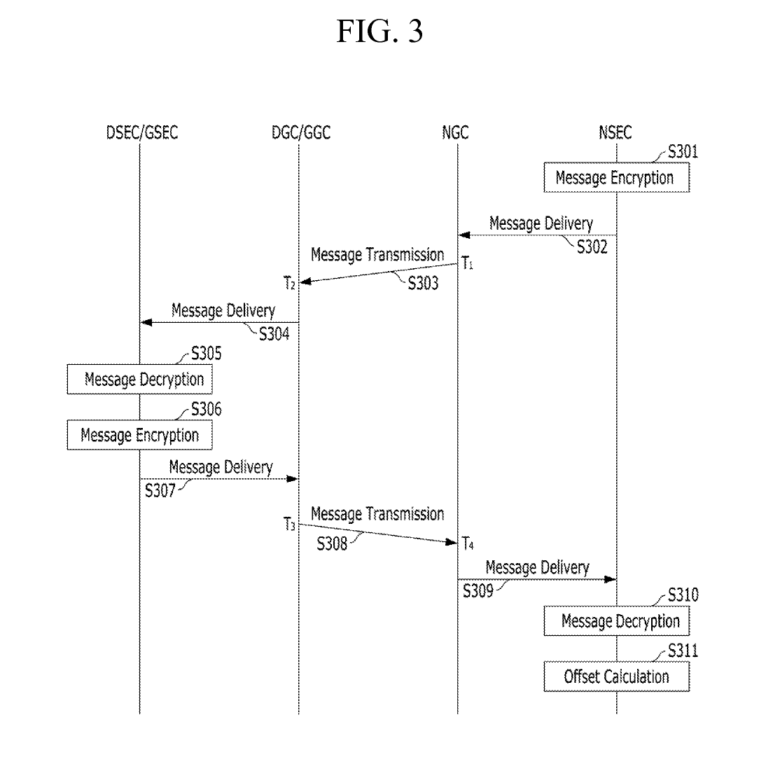

FIG. 3 is a flowchart illustrating a method of performing a time synchronization in accordance with Embodiment 1.

Referring to FIG. 3, at step S301, NSEC 121 of NSC 120 may encrypt a message (or packet) for a time synchronization. Herein, the message to be encrypted may include (i) an address of a transmission entity (e.g., NSC 120), (ii) an address of a reception entity (e.g., M2M devices 150a and 150b, or M2M gateway 180), and (iii) a time (T₁) when NSC 120 transmits encrypted information. Such information encryption may be performed using a key mutually shared between the transmission entity and the reception entity. That is, the key may be a root key K_{R}, a service key K_{S}, or an application key K_{A}. In NSEC 121, an encrypted message (e.g., Timing−message0) may be created by encrypting according to the following Formula 1 corresponding to an exemplary formula.

Timing−message0=MAC_{Ks}[node 1,node 2,N_{A},T₁] [Formula 1]

In Formula 1, ‘Timing−message0’ represents encrypted information, ‘node 1’ represents an address of a transmission entity (e.g., NSC 120), and ‘node 2’ represents an address of a reception entity (e.g., M2M device 150a or 150b, or M2M gateway 180). ‘N_{A}’ represents random numbers for prevention of a delay attack. ‘T₁’ represents ‘a transmission time of the encrypted information’ (i.e., a time when the encrypted information is transmitted). In Formula 1 above, a migration authorization code (MAC) is used as an encryption scheme, but other encryption schemes may be used. Furthermore, in Formula 1 above, a service key K_{S} is used for encryption, but a different key shared between NSC 120 and an M2M device/gateway (e.g., M2M device 150a or 150b, or M2M gateway 180) may be used.

At step S302, information encrypted in NSEC 121 may be delivered to NGC 122. At step S303, the delivered information may be transmitted from NGC 122 at the time T₁. At step S304, the encrypted information transmitted from NGC 122 may be received by DGC/GGC (e.g., DGC 153a or 153b, or GGC 183) at the time T₂, and the received information may be delivered to DSEC/GSEC (e.g., DSEC 152a or 152b, or GSEC182). At step S305, the encrypted information which is transmitted from NGC 122 and delivered through DGC/GGC (e.g., DGC 153a or 153b, or GGC 183) may be decrypted using a shared key by DSEC/GSEC (e.g., DSEC 152a or 152b, or GSEC182).

At step S306, DSEC/GSEC (e.g., DSEC 152a or 152b, or GSEC182) may encrypt a message (or packet) for a time synchronization. Herein, the message to be encrypted may include (i) an address of a transmission entity (e.g., M2M device 150a or 150b, or M2M gateway 180), (ii) an address of a reception entity (e.g., NSC 120), (iii) a transmission time T₁ of information transmitted at step S302, (iv) a reception time T₂ of information received at step S303, and (v) a time (T₃) when the transmission entity transmits encrypted information. Such information encryption may be performed using a key mutually shared between the transmission entity and the reception entity. That is, the key may be a root key K_{R}, a service key K_{S}, or an application key K_{A}. In DSEC/GSEC (e.g., DSEC 152a or 152b, or GSEC182), an encrypted message (e.g., Timing−message1) may be created by encrypting according to the following Formula 2 corresponding to an exemplary formula.

Timing−message1=MAC_{Ks}[node 2,node 1,N_{A},T₁,T₂,T₃] [Formula 2]

In Formula 2, ‘Timing−message1’ represents encrypted information, ‘node 2’ represents an address of a transmission entity (e.g., M2M device 150a or 150b, or M2M gateway 180), and ‘node 1’ represents an address of a reception entity (e.g., NSC 120). ‘N_{A}’ represents random numbers for prevention of a delay attack. Herein, the random numbers of Formula 2 may be different from the random numbers of Formula 1. ‘T₁’ represents a time when the encrypted information of Formula 1 is transmitted. ‘T₂’ represents a time when the encrypted information of Formula 1 is received. ‘T₃’ represents a time when the encrypted information of Formula 2 is transmitted. In Formula 2 above, a migration authorization code (MAC) is used as an encryption scheme, but other encryption schemes may be used. Furthermore, in Formula 2 above, a service key K_{S} is used for encryption, but a different key shared between NSC 120 and an M2M device/gateway (e.g., M2M device 150a or 150b, or M2M gateway 180) may be used.

At step S307, information encrypted in DSEC/GSEC (e.g., DSEC 152a or 152b, or GSEC182) may be delivered to DGC/GGC (e.g., DGC 153a or 153b, or GGC 183). At step S308, DGC/GGC (e.g., DGC 153a or 153b, or GGC 183) may transmit the delivered information at the time T₃. At step S309, NGC 122 may receive the encrypted information transmitted from DGC/GGC (e.g., DGC 153a or 153b, or GGC 183), at the time T₄, and deliver the received information to NSEC 121. At step S310, the encrypted information delivered from NGC 122 may be decrypted using a shared key by NSEC 121.

At step S311, NSEC 121 may calculate a time offset κ using T₁ through T₄. The time offset κ may be determined (or calculated) by Formula 3 below.

$$θ = \frac{( {T}_{2} - {T}_{1} ) + ( {T}_{4} - {T}_{3} )}{2} \qquad [ Formula 3 ]$$

The time offset θ calculated by Formula 3 may be used when NSC 120 and an M2M device/gateway (e.g., M2M device 150a or 150b, or M2M gateway 180) perform a time synchronization. In other words, the time offset θ may be used to modify time of an internal clock of the M2M device/gateway (e.g., M2M device 150a or 150b, or M2M gateway 180). The time offset θ calculated in NSEC 121 of NSC 120 may be transmitted to the M2M device/gateway (e.g., M2M device 150a or 150b, or M2M gateway 180). Alternatively, an M2M device/gateway (e.g., M2M device 150a or 150b, or M2M gateway 180) may independently calculate a time offset θ (e.g., 0=T₂−T₁) using the times T₁ and T₂.

### Embodiment 2

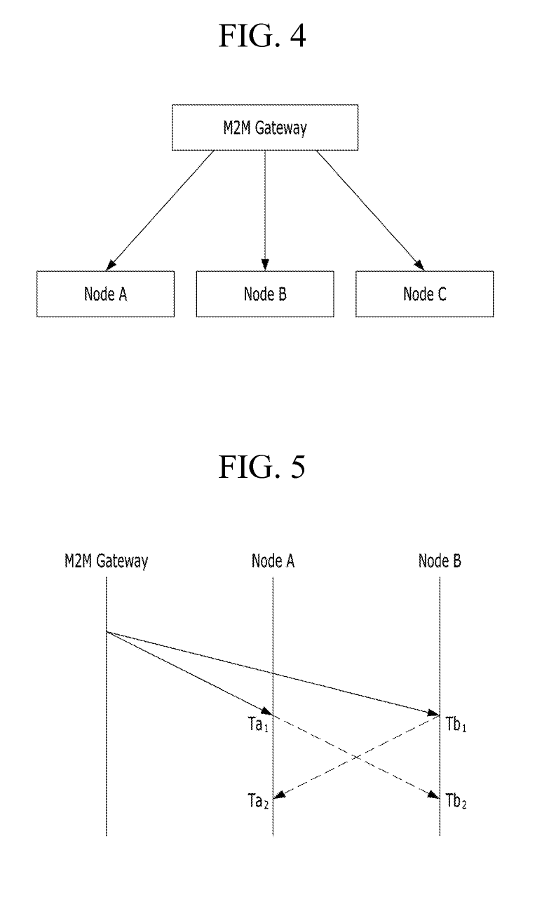

FIG. 4 illustrates a system to which the present embodiment (e.g., Embodiment 2) may be applied.

Referring to FIG. 4, an M2M gateway may be a reference node for time information. Accordingly, a plurality of nodes (i.e., a plurality of M2M devices, for example, M2M device 160 of a D′-type) may be simultaneously connected to the M2M gateway through an M2M area network. In other words, the plurality of nodes may proceed with a time synchronization using time information obtained from the M2M gateway.

The M2M gateway may correspond to a reference node for time information, and may transmit time messages to neighboring M2M devices (e.g., Node A through Node C) using a unidirectional broadcast.

FIG. 5 is a time-series diagram for explanation of a method of performing a time synchronization in accordance with the present embodiment (e.g., Embodiment 2). In FIG. 5, the vertical axis represents a time direction.

Referring to FIG. 5, a broadcast signal from an M2M gateway may be transmitted to nodes (e.g., Node A and Node B). A node (e.g., Node A) may receive the broadcast signal from the M2M gateway at the time Tₐ₁, and another node (e.g., Node B) may receive the broadcast signal from the M2M gateway at the time Tₕᵢ.

When receiving the broadcast signal from the M2M gateway, each node (e.g., Node A or Node B) may encrypt a message including a corresponding reception time (e.g., Tₐ₁ or T_{b1}). Encrypted messages (e.g., Timing−message_A and Timing−message_B) may be created by encrypting according to the following Formula 4 corresponding to an exemplary formula.

Timing−message_A=MAC_{K}[node A,node B,N_{A},Tₐ₁]

Timing−message_B=MAC_{K}[node B,node A,N_{A},T_{b1}] [Formula 4]

In Formula 4, the first line (i.e., the first formula associated with ‘Timing−message_A’) represents a formula associated with a message encryption of a node (e.g., Node A), and the second line (i.e., the second formula associated with ‘Timing−message_B’) represents a formula associated with a message encryption of another node (e.g., Node B). In Formula 4, ‘node A’ represents an address of Node A, and ‘node B’ represents an address of Node B. ‘N_{A}’ represents random numbers for prevention of a replay attack. The random numbers of the first line (i.e., the first formula) and the random numbers of the second line (i.e., the second formula) may be different. Each of ‘Tₐ₁’ and ‘T_{b1}’ represents a reception time when a corresponding node (e.g., Node A or Node B) receives a broadcast signal transmitted from the M2M gateway. Furthermore, the above-described information may be encrypted using a shared key (K) (e.g., a key shared between Node A and Node B) in nodes (e.g., Node A and Node B). For example, the above-described information may be encrypted by an MAC encryption scheme.

A message encrypted in a certain node (e.g., Node A) may be transmitted to a different node (e.g., Node B), and a message encrypted in the different node (e.g., Node B) may be transmitted to the certain node (e.g., Node A). Each node (e.g., Node A or Node B) receiving an encrypted message may extract time information (e.g., Tₐ₁ or Tₕ₁) by decrypting the encrypted message, and may proceed with a time synchronization using the extracted time information and a reception time (e.g., Tₐ₁ or T_{b1}) of the encrypted message. More specifically, Node A may proceed with perform a time synchronization using (i) time information (T_{b1}) which is extracted from an encrypted message transmitted from Node B, and (ii) a reception time (Tₐ₂) of the encrypted message. Meanwhile, Node B may proceed with a time synchronization using (i) time information (Tₐ₁) which is extracted from an encrypted message transmitted from Node A, and (ii) a reception time (T_{b2}) of the encrypted message. Time synchronizations between nodes may proceed according to such time synchronization scheme described with reference to Node A and Node B.

The present embodiment was described for the case of D′-type M2M device 160 (i.e., an M2M device of a D′-type). Herein, the D′-type M2M device may be connected to an M2M gateway through an M2M area network. However, the present embodiment may be applied for the case of a plurality of ‘d-type M2M devices.’ Herein, the d-type M2M devices may be connected to an M2M gateway or an M2M device.

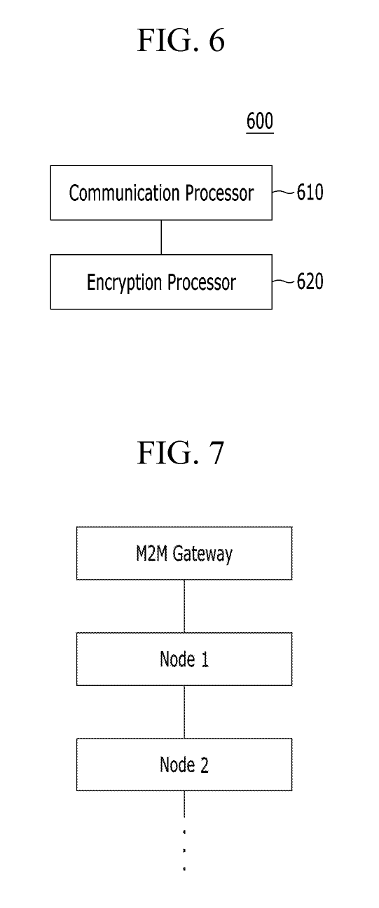

FIG. 6 is a block diagram illustrating a structure of an M2M device in accordance with the present embodiment (e.g., Embodiment 2).

M2M device 600 shown in FIG. 6 may be a D′-type M2M device or a d-type M2M device connected to an M2M gateway. Furthermore, M2M device 600 may include communication processor 610 and encryption processor 620.

In the case that M2M device 600 is an entity transmitting an encrypted message, encryption processor 620 may create a message by encrypting time information using a shared key. Herein, the shared key may be a key which M2M device 600 shares with a different M2M device connected through an M2M area network. Communication processor 610 may transmit the encrypted message to the different M2M device.

In the case that M2M device 600 is an entity receiving an encrypted message, communication processor 610 may receive the encrypted message which is created by a different M2M device connected through an M2M area network. Herein, the encrypted message may be created by encrypting time information using a shared key. In this case, the shared key may be a key shared between the different M2M device and M2M device 600. Encryption processor 620 may extract the time information by decrypting the encrypted message, and calculate a time offset based on the extracted time information and a reception time of the encrypted message. Encryption processor 620 may perform a time synchronization, using the calculated time offset.

Communication processor 610 may transmit an encrypted message or receive an encrypted message, according to the particular situation. Encryption processor 620 may encrypt ‘a message to be transmitted’ using a shared key, or decrypt a received message using the shared key.

### Embodiment 3

FIG. 7 illustrates a system to which the present embodiment (e.g., Embodiment 3) may be applied.

FIG. 7 illustrates a system in which a plurality of nodes are connected in series. Referring to FIG. 7, a certain node (e.g., Node 1) is directly connected to an M2M gateway, and a different node (e.g., Node 2) is connected to the M2M gateway through the certain (e.g., Node 1). The plurality of nodes may be connected in series in such a connection manner.

In this case, time synchronizations between entities may start from the M2M gateway, and may sequentially proceed.

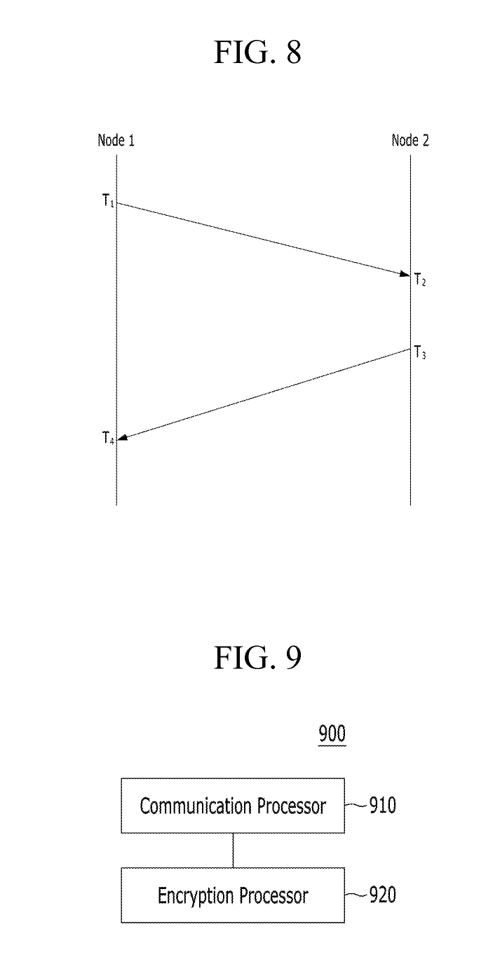

FIG. 8 illustrates a time synchronization process performed between two neighboring nodes. In FIG. 8, Node 1 is a node (e.g., an M2M device) which is closer to an M2M gateway, and Node 2 is a node which is farther away from the M2M gateway.

Node 1 may transmit an encrypted message at the time T₁. For example, the encrypted message may be a message encrypted by Formula 5 below.

Timing−message0=MAC_{K}[node 1,node 2,N_{A},T₁] [Formula 5]

In Formula 5, ‘node 1’ represents an address of Node 1, and ‘node 2’ represents an address of Node 2. ‘N_{A}’ represents random numbers for prevention of a replay attack, and ‘T₁’ represents a time when the encrypted message is transmitted from Node 1. The above-described information may be encrypted using a shared key (K). Herein, the shared key (K) may be a key shared between nodes (e.g., Node 1 and Node 2).

Such encrypted message may be received at the time T2 by Node 2, and Node 2 may extract time information (e.g., T₁) using the shared key (K).

Node 2 may transmit an encrypted message at the time T₃. Herein, the encrypted message may be created by an exemplary encryption process of Formula 6 below.

Timing−message1=MAC_{K}[node 2,node 1,N_{A},T₁,T₂,T₃] [Formula 6]

In Formula 6, ‘N_{A}’ may be a value different from N_{A} of Formula 5. ‘T₁’ represents a time when Node 1 transmits an encrypted message described in Formula 5. ‘T₂’ represents a time when Node 2 receives the encrypted message from Node 1. ‘T₃’ represents a time when Node 2 transmits an encrypted message described in Formula 6. The above-described information may be encrypted using a shared key (K). Herein, the shared key (K) may be a key shared between nodes (e.g., Node 1 and Node 2).

Such encrypted message (i.e., the encrypted message described in Formula 6) may be received by Node 1 at the time T₄, and Node 1 may extract time information (e.g., T₁, T₂, and T₃) using the shared key (K).

In this case, Node 1 may calculate a time offset using the same scheme as in Formula 3. Accordingly, Node 1 may modify a time offset between internal clocks of two entities (e.g., Node 1 and Node 2).

Such time synchronization may be first performed between an M2M gateway and the nearest node (e.g., M2M device) from the M2M gateway, and may be sequentially performed between neighboring nodes.

The present embodiment was described for the case of M2M devices connected in series from an M2M gateway. However, the present embodiment may be applied for a time synchronization between M2M devices connected in series from a reference M2M device (i.e., an M2M device capable of having a reference time).

In present embodiment, M2M devices may be D′-type M2M devices or d-type M2M devices.

FIG. 9 is a block diagram illustrating a structure of M2M gateway 900 in accordance with the present embodiment (e.g., Embodiment 3).

Referring to FIG. 9, M2M gateway 900 may include communication processor 910 and encryption processor 920. In the case that M2M gateway 900 communicates with a D′-type M2M device, communication processor 910 may correspond to a gateway application enablement (GAE) capability. In the case that M2M gateway 900 communicates with a d-type M2M device, communication processor 910 may correspond to a gateway interworking proxy (GIP) capability. Encryption processor 920 may correspond to a gateway security (GSEC) capability.

Encryption processor 920 may create an encrypted message (e.g., “Timing−message0”) using a shared key (i.e., a key shared with an M2M device). Herein, the encrypted message may include time information (T₁). Communication processor 910 may transmit the encrypted message (e.g., “Timing−message0”) to the M2M device at the time T₁.

The M2M device may receive the encrypted message (e.g., “Timing−message0”) at the time T₂, and extract time information (T₁). The M2M device may create an encrypted message (“Timing−message1”) using the shared key, and transmit the encrypted message (“Timing−message1”) to M2M gateway 900 at the time T₃. Herein, the encrypted message (“Timing−message1”) may include time information (T₃) as well as time information (T₁ and T₂).

Communication processor 910 may receive the encrypted message (“Timing−message1”) from the M2M device at the time T₄. Encryption processor 920 may extract time information (T₁, T₂, and T₃) by decrypting the received message (“Timing−message1”). Furthermore, encryption processor 920 may determine a time offset using the extracted time information (T₁, T₂, and T₃) and a reception time (T₄) of the message (“Timing−message1”).

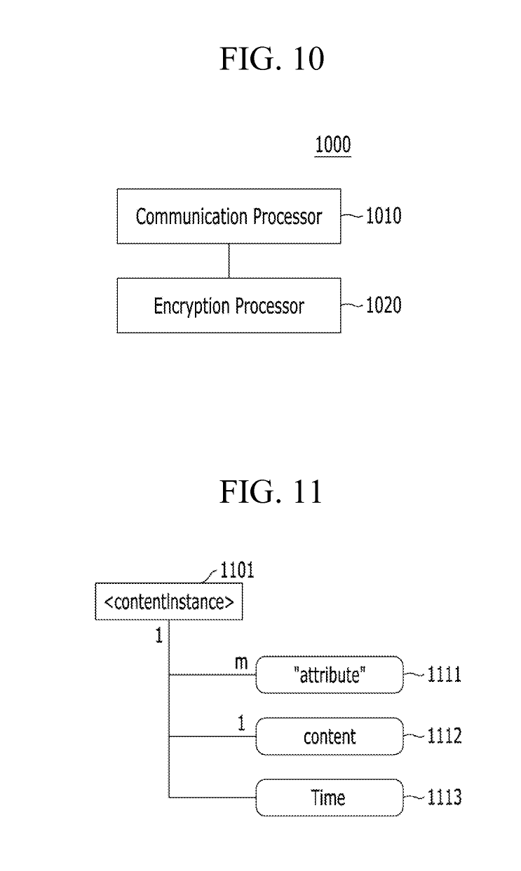

FIG. 10 is a block diagram illustrating a structure of M2M device 1000 in accordance with the present embodiment (e.g., Embodiment 3). M2M device 1000 may include communication processor 1010 and encryption processor 1020.

M2M device 1000 may proceed with a self time synchronization (i.e., a time synchronization for M2M device 1000) by communicating with (i) an M2M gateway or (ii) a different M2M device closer to the M2M gateway than M2M device 1000. Meanwhile, M2M device 1000 may proceed with a time synchronization for a different M2M device farther away from the M2M gateway than M2M device 1000, by communicating with the different M2M device. In other words, time synchronizations may proceed sequentially from the M2M gateway.

In the case that M2M device 1000 proceeds with a self time synchronization (i.e., a time synchronization for M2M device 1000), communication processor 1010 may receive an encrypted message (“Timing−message0”) from an M2M gateway or a different M2M device, at the time T₂. Herein, the encrypted message (“Timing−message0”) may include time information (T₁), and be created by encrypting using a shared key. Encryption processor 1020 may extract time information (T₁) by decrypting the received message (“Timing−message0”).

Encryption processor 1020 may create an encrypted message (“Timing−message1”). Herein, the encrypted message (“Timing−message1”) may include the extracted time information (T₁), a reception time (T₂) of the encrypted message (“Timing−message0”), and time information (T₃), and may be created by encrypting using the shared key. Communication processor 1010 may transmit the encrypted message (“Timing−message1”) at the time T₃, to the M2M gateway or the different M2M device which transmitted the encrypted message (“Timing−message0”) to M2M device 1000.

Meanwhile, in the case that M2M device 1000 proceeds with a time synchronization for a different M2M device, encryption processor 1020 may create an encrypted message (“Timing−message0”). Herein, the encrypted message (“Timing−message0”) may include time information (T₁), and be created by encrypting using a key shared with the different M2M device. Communication processor 1010 may transmit the encrypted message (“Timing−message0”) to the different M2M device at the time T₁.

When receiving the encrypted message (“Timing−message0”) at the time T₂, the different M2M device may extract time information (T₁) from the received message (“Timing−message0”). Thereafter, the different M2M device may create an encrypted message (“Timing−message1”) using the shared key. Herein, the encrypted message (“Timing−message1”) may include time information (T₁, T₂, and T₃). The different M2M device may transmit the created message (“Timing−message1”) to M2M device 1000 at the time T₃.

Communication processor 1010 may receive the encrypted message (“Timing−message1”) from the different M2M device at the time T₄. Encryption processor 1020 may extract time information (T₁, T₂, and T₃) by decrypting the received message (“Timing−message1”). Furthermore, encryption processor 1020 may determine (or calculate) a time offset using the extracted time information (T₁, T₂, and T₃) and a reception time (T₄) of the message (“Timing−message1”).

In the above-described embodiments, time information may be encrypted by a key shared between entities, and then transmitted. Accordingly, a security of the time information may be substantially guaranteed, and the time information may be protected from a malicious attack.

Meanwhile, in a system shown in FIG. 1, a RESTful architecture may be applied as a principle for exchanging information each other between M2M service capability layers (hereinafter refer to as “SCLs”) in NA 110, DAs 159a, 159b, and 169, GA 189, NSC 120, DSCs 151a and 151b, and/or GSC 181. The RESTful architecture may be referred to as “conform to a ‘representational state transfer (REST) principle.”

In the RESTful architecture, that there are resources each of which is represented as an identifier may be important. In order to handle such resources, network elements may communicate through standardized interfaces, and exchange representations of such resources. Herein, the network elements may be ‘SCLs’ in NA 110, DAs 159a, 159b, and 169, GA 189, NSC 120, DSCs 151a and 151b, and/or GSC 181 in a system shown in FIG. 1. Such resources may have a tree structure.

When handling resources in a RESTful architecture, the following four basic methods may be applied to the resources.
CREATE (C): Create sub-resources.
RETRIEVE (R): Read the content of the resource.
UPDATE (U): Write the content of the resource.
DELETE (D): Delete the resource.

These methods may be referred to as “CRUD methods.” In addition to the CRUD methods, a subscription (S) of a resource exchange, a notification (N) about an exchange of resources, and an execution (E) of a management command/task represented by a resource may be defined.

In order that the above-described time synchronization method can be applied to a system structure of FIG. 1, resources used in RESTful architecture may have a structure shown in FIG. 11.

Referring to FIG. 11, <contentInstance> resource 1101 may include such sub-resources (or may be referred to as “child resources”) as “attribute” 1111, content 1112, and Time 1113. “attribute” 1111 may indicate an attribute of <contentInstance>resource 1101. content 1112 may indicate a content of an instance. Time 1113 may indicate time information applied to the above-described embodiments. Information of Time 1113 may indicate time information of each M2M entity. Furthermore, information of Time 1113 may be determined by the above-described embodiments.

As shown in FIG. 11, Time 1113 may be located under <contentInstance> resource 1101. However, a Time resource may be located under a different resource according to necessity.

As described above, since the technical idea of the present invention is described by exemplary embodiments, various forms of substitutions, modifications and alterations may be made by those skilled in the art from the above description without departing from essential features of the present invention. Therefore, the embodiments disclosed in the present invention are intended to illustrate the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

### CROSS-REFERENCE TO RELATED APPLICATION

The present application claims priority under 35 U.S.C. §119(a) to Korean Patent Application No. 10-2011-0045421 (filed on May 13, 2011), which is hereby incorporated by reference in their entirety. In addition, the present application claims priority in countries, other than U.S., with the same reason based on the Korean Patent Applications, which are hereby incorporated by reference in their entirety.

1-47. (canceled)

48. A method of performing a time synchronization in a machine to machine (M2M) communication system in which M2M devices communicate with each other through at least one of a personal area network and a local area network, the method comprising:
receiving, by a second entity, an encrypted message from a first entity, wherein (i) the encrypted message is created by encrypting time information in the first entity, using a key shared with the second entity, and (ii) each of the first entity and the second entity is an M2M device;
obtaining, by the second entity, the time information by decrypting the encrypted message; and
calculating, by the second entity, a time offset based on the time information and a reception time of the encrypted message.

49. The method of claim 48, wherein:
the time information is information on a time when the first entity receives a signal broadcast from a third entity having reference time information; and
the third entity is an M2M gateway.

50. The method of claim 49, wherein the first entity and the third entity communicate through the at least one of the personal area network and the local area network.

51. A method of performing a time synchronization in a machine to machine (M2M) communication system including at least one of an M2M platform, one or more M2M gateways, and one or more M2M devices, the method comprising:
receiving, by a second entity, a first message at a second time, when a first entity (i) creates the first message by encrypting a first time information using a key shared with the second entity, and (ii) transmits the first message to the second entity at a time corresponding to the first time information;
obtaining, by the second entity, the first time information by decrypting the first message;
creating, by the second entity, a second message by encrypting the first time information, information on the second time, and a third time information using the key; and
transmitting, by the second entity, the second message to the first entity, at a time corresponding to the third time information,
wherein the second entity is an M2M device or an M2M gateway.

52. The method of claim 51, wherein the first entity is the M2M platform.

53. The method of claim 52, wherein the key is one of a root key, a service key, and an application key.

54. The method of claim 52, wherein the second entity communicates with the first entity through a core network and an access network.

55. The method of claim 51, wherein:
the first entity is an M2M device or an M2M gateway; and
the second entity is the M2M device communicating with the first entity.

56. The method of claim 55, wherein the second entity communicates with the first entity through at least one of a personal area network and a local area network.

57. A method of performing a time synchronization in a machine to machine (M2M) communication system including at least one of an M2M platform, one or more M2M gateways, and one or more M2M devices, the method comprising:
creating, by a first entity, a first message by encrypting a first time information using a key shared with a second entity;
transmitting, by the first entity, the first message to the second entity;
receiving, by the first entity, a second message at a fourth time, when the second entity (i) creates the second message by encrypting the first time information, a second time information associated with a first message reception of the second entity, and a third time information, using the key, and (ii) transmits the second message at a time corresponding to the third time information;
obtaining, by the first entity, the first time information, the second time information, and the third time information by decrypting the second message; and
calculating, by the first entity, a time offset based on the first time information, the second time information, the third time information, and information on the fourth time,
wherein the second entity is an M2M device or an M2M gateway.

58. The method of claim 57, wherein the first entity is the M2M platform.

59. The method of claim 58, wherein the key is one of a root key, a service key, and an application key.

60. The method of claim 58, wherein the first entity communicates with the second entity through a core network and an access network.

61. The method of claim 57, wherein:
the first entity is an M2M device or an M2M gateway; and
the second entity is the M2M device communicating with the first entity.

62. The method of claim 61, wherein the first entity communicates with the second entity through at least one of a personal area network and a local area network.
